(19) United States
(12) Patent Application Publication
(10) Pub. No.: US 2012/0287546 A1
(43) Pub. Date: Nov. 15, 2012

(54) SENSOR-ACTIVATED CIRCUIT-INTERRUPTING APPARATUS AND METHOD OF USING SAME

(76) Inventor: Robert Z. KOPELMAN, Rockville Centre, NY (US)

(21) Appl. No.: 13/468,814

(22) Filed: May 10, 2012

Related U.S. Application Data
(60) Provisional application No. 61/518,682, filed on May 10, 2011.

(51) Int. Cl. H02H 5/04

(52) U.S. Cl. 361/105; 361/103

(57) ABSTRACT

A circuit-interrupting system for interrupting an electrical current to a device is provided including a relay assembly configured to be operable in a closed state when a sensed temperature is below a predetermined threshold, thereby maintaining electrical current to the device, and an open state when the sensed temperature is above the predetermined threshold, thereby interrupting the electrical current to the device. A heater element is provided proximal to said relay assembly and configured to activate at least the open state of the relay assembly. At least one sensor in electrical communication with the heater element is provided disposed remote from the relay assembly and being configured for sensing temperatures, wherein when the sensed temperature at said at least one sensor is above the predetermined threshold, the at least one sensor is configured to cause the heater element to activate the open state of the relay assembly.

### CROSS REFERENCE TO RELATED APPLICATIONS

This application claims priority from U.S. Provisional Patent Application Ser. No. 61/518,682 filed on May 10, 2011 and entitled “Bi-metal apparatus used as a relay with remote control sensing and a heating element to activate the relay,” the entire contents of which are incorporated herein by reference.

### BACKGROUND

1. Technical Field

The present disclosure relates generally to apparatus and methods for preventing and controlling electrical overheating, and more specifically to an apparatus used as a bi-metal relay having remote sensing and heating elements to activate the relay and method of using same. It also includes a mechanism for maintaining the relay in the open position until a problem has been addressed.

2. Description of Related Art

Relays have been used for many years in the electrical industry and in particular, with respect to electrical appliances. There exist numerous types of relays having various operational characteristics, including electromechanical, electric pneumatic, mechanical electrical, pneumatic electric and electronic relays. Relays are usually activated by an outside source, which may comprise, e.g., a mechanical electrical or electronic source, etc.

However, relays in prior applications present a number of disadvantages. For example, prior relays cannot be used in confined or limited spaces and/or for monitoring multiple locations simultaneously. Furthermore, over time they can create a humming sound or vibrating sound.

Accordingly, an improved relay that can be used with electronic or electrically operated devices which obviates the disadvantages of prior art arrangements is highly desirable.

### SUMMARY OF THE INVENTION

According to various embodiments, the present invention provides for a temperature sensitive and controlled circuit-interrupting module configured to disconnect a load from a power source with the occurrence of an over-temperature event detected by any of one or more sensors disposed at any location at, within or proximate to a device desired to be monitored. In some embodiments, the present invention is directed to a circuit-interrupting module for providing opening and closing of contacts as needed by a particular application. According to various advantageous aspects, a circuit-interrupting module according to the present invention may be provided appropriately sized to enable its installation within an existing electrical device, is robust, has a tremendous life cycle, has proven technology for its resistance characteristics, and its contacts can be rated at high amperages and high voltages.

Advantageously, a circuit-interrupting module according to various embodiments of the present invention is not required to be located at or near the physical location of the overheating problem. Effective monitoring of a device and activation of the circuit-interrupting module upon, e.g., the device's overheating may be provided via, e.g., its capability to operate with one or more remote sensors.

Furthermore, a circuit-interrupting module or relay according to various embodiments of the present invention can be held in the open position indefinitely without any chattering or humming. A relay according to various embodiments can be used to detect problems such as over-temperature and/or glowing connection conditions throughout a device at multiple locations simultaneously in a cost-effective manner.

One object of the present invention is to provide a relay that can be used in existing electrical products to shut down the incoming power source.

Another object of the invention is a relay comprised of a bi-metal assembly with contact points for interrupting an electrical load.

Another object of the invention is a relay which may include a heating element such as e.g., a PTC (Positive Temperature Coefficient) material or similar heated resistor to maintain the relay in an open position.

A further object of the invention is a relay which may include a plurality of heating elements that will activate the relay when heated.

Yet another object of the invention includes a second heating element which can be activated in a number of ways.

Yet another object of the invention is having the function of a first and second heating element performed by a single heating element to open and maintain heating of a bi-metal relay.

Still yet another object of the invention is to provide a heating element which can be activated by resistors including NTC (Negative Temperature Coefficient) resistors, PTC resistors, thermistors, infrared sensing, or any other means for detecting heat at remote locations.

Another object of the invention is to provide one or more relay contacts which are designed to withstand large currents and/or inrush currents.

Another object of the invention is to provide an inexpensive means to detect over-temperature conditions in remote locations of an appliance and shut down a power source to the appliance to prevent overheating and/or a fire. A further object of the invention is to provide a relay which may be installed in any appliance or product that has the potential to overheat or start a fire.

Yet another object of the invention is to provide a relay which may be controlled by external sensors. This advantageously imparts versatility in providing a relay which may be used to replace existing relays that are used in today's appliances and/or to supplement existing relays to monitor multiple locations at the same time to prevent overheating and fires.

According to one aspect, a circuit-interrupting system for interrupting an electrical current to a device is provided including a relay assembly configured to be operable in a closed state when a sensed temperature is below a predetermined threshold, thereby maintaining electrical current to the device, and an open state when the sensed temperature is above the predetermined threshold, thereby interrupting the electrical current to the device. A heater element is provided proximal to said relay assembly and being configured to activate at least the open state of the relay assembly. At least one sensor in electrical communication with said heater element, said at least one sensor being disposed remote from said relay assembly and being configured for sensing temperatures, wherein when the sensed temperature at said at least one sensor is above the predetermined threshold, the at least one sensor is configured to cause the heater element to activate the open state of the relay assembly.

According to another aspect, a circuit-interrupting system for interrupting an electrical current to a device is provided comprising a relay assembly configured to be operable in a closed state for maintaining electrical current to the device, and an open state for stopping the electrical current to the device. A sensing circuit is provided comprising a heating element proximal to said relay assembly and being configured to activate at least the open state of the relay assembly and at least one sensor in electrical communication with said heating element, said at least one sensor being disposed remote from said relay assembly.

According to yet another aspect, a circuit-interrupting system for interrupting an electrical current to a device is provided comprising a relay assembly configured to be operable in a closed state for maintaining electrical current to the device, and an open state for interrupting the electrical current to the device, a heater element proximal to said relay assembly and being configured to activate at least the open state of the relay assembly, and at least one sensor in electrical communication with said heater element, said at least one sensor being disposed remote from said relay assembly and being configured for sensing temperatures, wherein when the sensed temperature at said at least one sensor is above the predetermined threshold, the at least one sensor is configured to cause the heater element to activate the open state of the relay assembly. A holding sensor is provided in electrical communication with and in proximity to said heater element, said holding sensor configured to be activated by the open state of the relay assembly.

These and other aspects, features and advantages of the present invention will be described or become apparent from the following detailed description, which is to be read in connection with the accompanying drawings.

### BRIEF DESCRIPTION OF THE DRAWINGS

The drawings constitute a part of this specification and include exemplary embodiments to the invention, which may be embodied in various forms. It is to be understood that in some instances various aspects of the invention are not drawn to scale and may be shown exaggerated or enlarged to facilitate an understanding of the invention.

FIG. 1 depicts a schematic view of a sensor-activated circuit-interrupting system in normal operation according to an exemplary embodiment;

FIG. 2 depicts a schematic view of a sensor-activated circuit-interrupting system during detection of an overheated condition according to an exemplary embodiment;

FIG. 3 depicts a schematic view of a sensor-activated circuit-interrupting system according to an alternate exemplary embodiment;

FIG. 4 is a block diagram of exemplary components of a sensor-activated circuit-interrupting system;

FIG. 5 is an exemplary internal perspective view of a dryer appliance having a sensor-activated circuit-interrupting system according to an exemplary embodiment; and

FIG. 6 is a flow diagram of an exemplary method for providing a sensor-activated circuit-interrupting system and monitoring one or more locations of a device according to an exemplary embodiment.

### DETAILED DESCRIPTION

Detailed descriptions of the embodiments of the present invention are provided herein. While multiple embodiments are disclosed, still other embodiments of the present invention will become apparent to those skilled in the art from the following detailed description. It is to be understood, however, that the present invention may be embodied in various forms. As will be apparent, the invention is capable of modifications in various obvious aspects, all without departing from the spirit and scope of the present invention. Therefore, specific details disclosed herein are to be regarded as illustrative in nature and not to be interpreted as limiting or restrictive, but rather as a basis for the claims and as a representative basis for teaching one skilled in the art to employ the present invention in virtually any appropriately detailed system, structure or manner.

The present disclosure relates to a safety device that is enabled to monitor temperature in multiple locations when electrical power is being used on a product, appliance, or anything electrically operated that may have the potential to overheat.

The present disclosure is directed towards a circuit-interrupting system which includes a relay configured to be in communication with one or more sensors that can be situated at any location throughout a device to monitor for temperatures that may indicate a dangerous condition. If any of the one or more sensors detects a dangerous temperature, it activates the relay to disconnect the flow of electricity before a fire can start. In some embodiments, the present disclosure comprises a relay that is operable between a closed position or closed state when the device being monitored is operating normally, and an open position or open state when the temperature of the monitored locations is above a predetermined temperature threshold. In some embodiments, an over-temperature event may require manual resetting to again enable power to be coupled to the device (load). Manually resetting the load may require shutting off the power supplying the load (e.g., pulling the plug of the device).

Advantageously, a system according to the present principles is configured to be able to continuously monitor multiple regions and areas of a device simultaneously and upon detecting when temperatures approach a predetermined dangerous level at any one area, can automatically shut down the flow of electrical current to the device, thereby preventing overheating and/or combustion. According to some embodiments, to further ensure safety, the circuit-interrupting module can be configured in such a way that reestablishing electrical current to the device will thereafter require manual human intervention, such as e.g., unplugging and re-plugging the device.

In many cases, a product's existing components can be repurposed to accommodate a system according to the present principles, and/or only incorporate components that are readily available. Thus, a circuit-interrupting system according to the present principles is extremely cost-effective and will not impact an appliance or device's size or function.

According to various embodiments, a circuit-interrupting system including a bi-metal relay is provided configured to be controlled by one or more remote sensors. Advantageously, a relay device is accordingly provided that is inexpensive, easily implemented into existing devices and may be easily configured to perform detection of over-temperature conditions at one or more locations desired to be monitored.

Exemplary locations at which a circuit-interrupting module according to the present invention may be implemented may include locations within, near or around electrical appliances (e.g., such as washers, dryers, dishwashers, refrigerators, ranges, toasters, toaster ovens, air conditioners, ice makers, microwave ovens, etc.), power strips, electrical outlets, GFI outlets, electrical cords and plugs, batteries (e.g., such as lithium-ion batteries), motors, electric burner tops, through-the-wall AC units and AC units with remote compressors, or any device or product that has the potential to overheat and/or cause a fire.

In accordance with an exemplary embodiment of the invention, a system for monitoring, detecting and preventing overheating of a device is provided comprising a circuit-interrupting module (e.g., a relay) which includes a bi-metal actuator attached to electrical contacts for allowing electrical power to flow from a power source to a device. The circuit-interrupting module may be disposed remotely from the location(s)/device being monitored. The circuit-interrupting module may comprise a heating element in proximity to the bi-metal actuator which is operatively connected and responsive to one or more sensors which may be located in any of the area(s) to be monitored. The circuit-interrupting module may include one or more sensors which may be disposed remotely from the bi-metal actuator. When the one or more sensors detect an unsafe thermal condition, electrical current is allowed to flow through at least the heating element. This activates the circuit-interrupting module by opening the bi-metal actuator, thus interrupting the circuit and stopping the flow of electrical power to the device.

In various alternate embodiments, a circuit-interrupting module or relay according to the present principles may be configured to be in communication with and cause a shut off of a master relay, rather than or in addition to, a shut off of electrical current to the device. The master relay may be at any location internal or external to a device being monitored. In various embodiments, when a predetermined over-temperature condition is detected a circuit-interrupting module according to the present invention will send an instruction to one or more installed ‘master’ relays that can, e.g., be a simple relay, a dedicated temperature sensing microprocessor, an appliance or device's existing microprocessor(s), or any relay controlling any aspect of the device.

In various embodiments, a circuit-interrupting module according to the present invention is advantageously small and compact, has an extended life expectancy, can be maintained in the open position until the overheating problem is resolved, can be installed in confined and limited spaces such as a power strip, electric outlet, and any electrical appliance large and small, and is inexpensive to manufacture, operate and install. For example, the cost of the heating element to activate the relay is inexpensive, the cost of the heating element to hold the relay in the open position is inexpensive, the cost of the remote sensors themselves are inexpensive and the remote sensors are easily installed in remote locations of a device or electrical product.

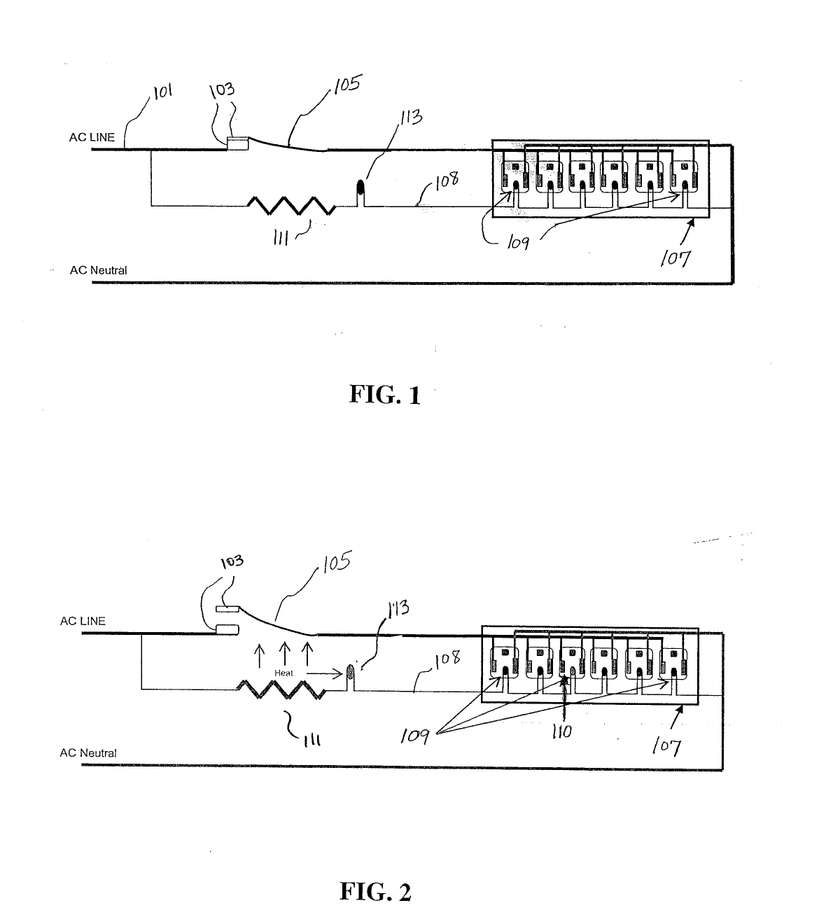

Turning now to the Figures, FIG. 1 depicts a schematic view of a sensor-activated circuit-interrupting system in normal operation according to an exemplary embodiment. A circuit-interrupting module 105 may be provided attached to electrical contacts 103 which allow electrical power to flow from a power source (not shown) via AC line 101 to an appliance 107 when heating element 111 is ‘cool,’ i.e., when element 111 is not activated.

When the appliance 107 is operating normally, the circuit-interrupting module 105 remains closed maintaining the circuitry required to allow the appliance 107 to operate as intended.

In various embodiments, one or more temperature-gauging/thermal sensors may be provided and placed at a location desired to be monitored at, within or proximate to a device or appliance. For example, sensors may be placed at an appliance's strategic points where over-temperature conditions are more likely to occur, e.g., at a male plug, electrical cord and electrical connection points where the electrical cord interfaces with the appliance's workings, and at a device's motor, power transformers and relay. Exemplary types of sensors include thermistors, single wire temperature sensors, infrared sensors and infrared sensors in combination with fiber optics, although other types of sensors may be contemplated. According to some embodiments, the sensors are linked together to form a network to provide continuous, simultaneous surveillance. The sensors may be linked in series, in parallel, and any combination of same.

According to some embodiments, a circuit-interrupting module or relay according to the present principles is capable of operating on various amperages and voltages including AC and DC Power. In various embodiments, a circuit-interrupting module or relay according to the present principles is capable of 1-Pole input or multiple pole input (e.g., 2-pole, 3-pole) to control a plurality of products and devices, whether from inside the product or device and/or external control of sensing that feeds a device or product, e.g., motor control, etc.

In the exemplary embodiment depicted in FIG. 1, an exemplary circuit-interrupting module is shown implemented in an appliance 107 being monitored. In this embodiment, the circuit-interrupting module may comprise at least the components 103, 105, 111 and 113, each described in further detail below. For exemplary purposes, the appliance 107 is shown herein operating on AC power and may comprise, e.g., a power strip having a plurality of outlets, each of which includes a sensor 109 configured to monitor the thermal conditions at each outlet.

Each of the sensors 109 is functionally connected to the heating element 111 and together, the sensor(s) 109 and heating element 111 form a separate sensing circuit 108 which, e.g., runs off the AC line 101. An additional sensor 113 may be provided connected in close proximity to the heating element 111 and may function as a holding sensor, explained further below with reference to FIG. 2.

The circuit-interrupting module may include a relay assembly comprising a bimetallic actuator or strip 105 used to convert a temperature change into mechanical displacement. The bimetallic actuator 105 may comprise two attached strips of different metals which expand at different rates as they are heated. The different expansions force the flat strip to bend one way if heated, and in the opposite direction if cooled below its initial temperature. The heating element 111 is located proximate to the bimetallic actuator 105 at a sufficiently close distance such that heat emitted from the element 111 will cause the bimetallic actuator 105 to bend in a first direction sufficient to open the contacts 103.

The relay assembly 105 may be configured to be operable in a closed state (e.g., as shown in FIG. 1) when a sensed temperature (sensed by the sensor(s) 109) is below a predetermined threshold, thereby maintaining electrical current to a device or appliance, and an open state (e.g., as shown in FIG. 2) when a sensed temperature is above the predetermined threshold, thereby interrupting the electrical current to a device or appliance.

FIG. 2 depicts a schematic view of a sensor-activated circuit-interrupting system during detection of an overheated condition according to an exemplary embodiment. When one or more of the thermal sensors 109 detects an unsafe thermal condition, such as a temperature exceeding a predefined threshold, that sensor's resistance is decreased, thus causing an increase in the electrical current flowing through the sensing circuit 108 and thus through the heating element 111.

In the exemplary embodiment shown, outlet 110 is overheated, thus increasing the temperature in its proximity and activating one of the sensors 109.

This action causes current flow to increase to the heating element 111 which in turn causes the heating element 111 to generate heat, thus causing the bending of the bimetallic actuator 105. This results in the electrical contacts 103 being opened and thus activates an open state of the circuit, accordingly stopping the flow of electrical power to the appliance 107.

In some embodiments, the bimetallic actuator 105 may be configured to automatically return to a closed position and thus power may be automatically restored to the appliance 107 when the thermal sensor(s) 109 no longer detects an unsafe heating condition. For example, such an embodiment may be provided by eliminating the holding sensor 113, so that when the overheated area cools down, current through the sensing circuit 108 is reduced, and the bimetal actuator 105 is allowed to cool, thus closing the contacts 103 and restoring the closed state of the circuit and hence the flow of electrical power to the appliance 107 automatically.

Alternatively, in other embodiments, in order to keep the circuit-interrupting module 105 holding the electrical contacts 103 open until the unsafe heating condition can be addressed, the holding thermal sensor 113 may be provided affixed near the heating element 111 for causing the heating element 111 to continue to operate (i.e., to maintain current flow through the sensing circuit 108) regardless of the loss of electrical power to the appliance 107. In this case, bimetal actuator 105 holds contacts 103 open until all power is removed from the sensing circuit 108. That is, the heat emitted from the heating element 111 lowers the resistance of the holding sensor 113 which permits an increase in the current flow through the sensing circuit 108 such that the heating element 111 will continue to heat open the bimetal actuator 105 until, e.g., the underlying condition which initially created the unsafe heating condition is addressed.

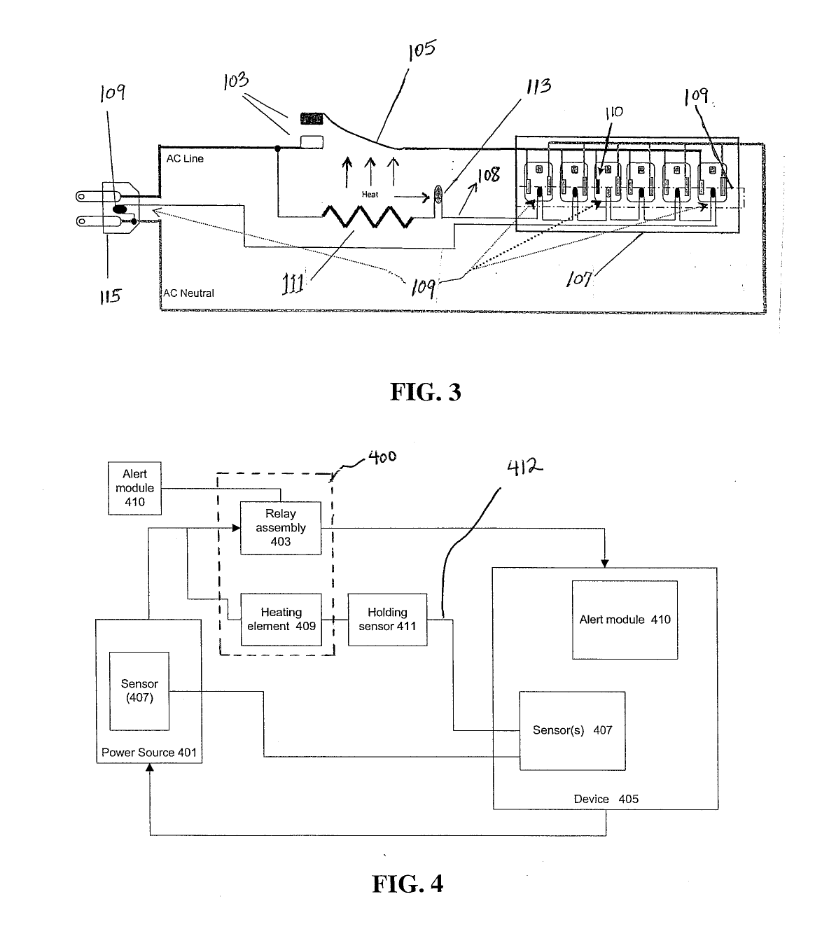

In some embodiments, an alert module may be provided which may be triggered by the activation of one or more of the sensor(s) 109 and/or the activation of the circuit-interrupting module. The alert module (described further in FIG. 4) may comprise an audio and/or visual alert device, such as an indicator light or noise, to alert the user that an overheat condition has been detected.

FIG. 3 depicts a schematic view of a sensor-activated circuit-interrupting system according to an alternate embodiment, in which a sensor 109 is further incorporated at a power source 115. Thus, the sensing circuit 108 is comprised of the heating element 111, sensors 109 disposed at each of a plurality of outlets on a power strip 107 and at a power source 115, and a holding sensor 113.

FIG. 4 is a block diagram of exemplary components of a sensor-activated circuit-interrupting system, and generally presents an alternate schematic view of the system shown in FIG. 3, while including an alert system to notify the user of an overheat condition. A circuit-interrupting module 400 may comprise a switch/bimetal actuator 403 and a heating element 409, and optionally, may also include a holding sensor 411. At least one sensor 407 may be provided at or around a device 405 being monitored, and optionally, at least one sensor may be provided in/around a power source 401 supplying energy to the device 405. In one embodiment, the sensing circuit 412 may thus comprise the heating element 409, holding sensor 411, and at least one sensor 407. In other embodiments, the sensing circuit 412 may comprise the heating element 409 and at least one sensor 407.

Advantageously, each sensor 407 may be oriented remotely from the circuit-interrupting module 400, that is, at any location that is not within proximity of the circuit-interrupting module 400. Despite the remote placement of the sensors, effective activation of the circuit-interrupting module 400 is nevertheless enabled, and an improved comprehensive monitoring of a device 405 is provided.

An alert module 410 may be provided which may be triggered by the activation of one or more of the sensor(s) 407 and/or the activation of the circuit-interrupting module 400. The alert module 410 may be functionally connected to one or more sensors 410 and/or the relay assembly 403, and may be physically located internal or external to the device 405 at any location. Exemplary alert modules may be enabled to provide audio alerts such as constant or intermittent noises, and/or visual alerts such as blinking indicator lights, when the circuit-interrupting system is activated.

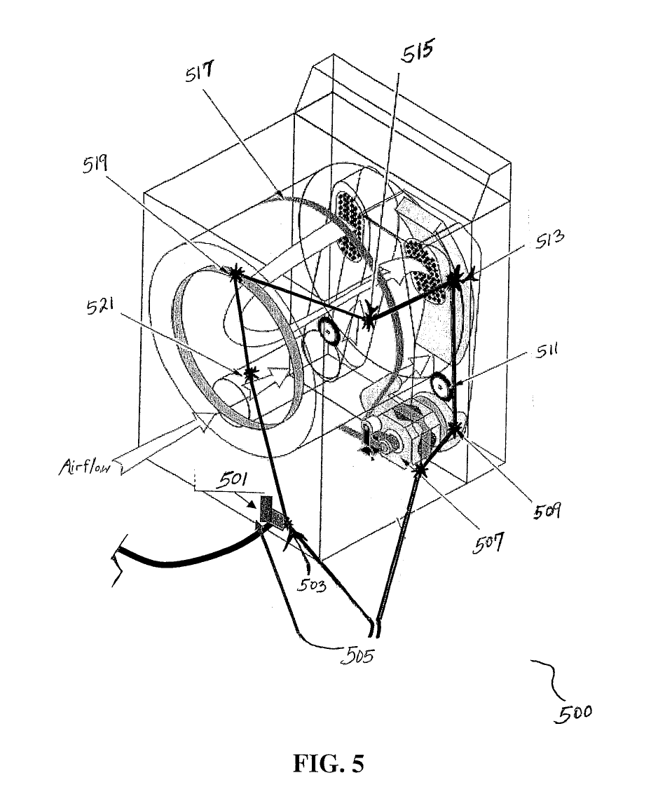

FIG. 5 is an exemplary internal perspective view of a dryer appliance having a sensor-activated circuit-interrupting system according to one embodiment. A typical dryer may include components such as a drive motor 507, blower 509, rear support rollers 511, a lint screen 513, a heater box 515, a drive belt 517, a drum bearing ring 519, a burner chamber 521. A plurality of remote sensors may be installed and placed at or around any of these components or other components to monitor their temperature conditions, and may be connected to form a sensor network 505 in electrical communication with a circuit-interrupting module 501, The circuit-interrupting module 501 may be installed at a power-in 503 as shown, or at any other location. A sensor may further be included in the circuit-interrupting module 501. In operation, if any of the sensors in the network 505 detect an overtemperature condition, this will activate the circuit-interrupting module 501.

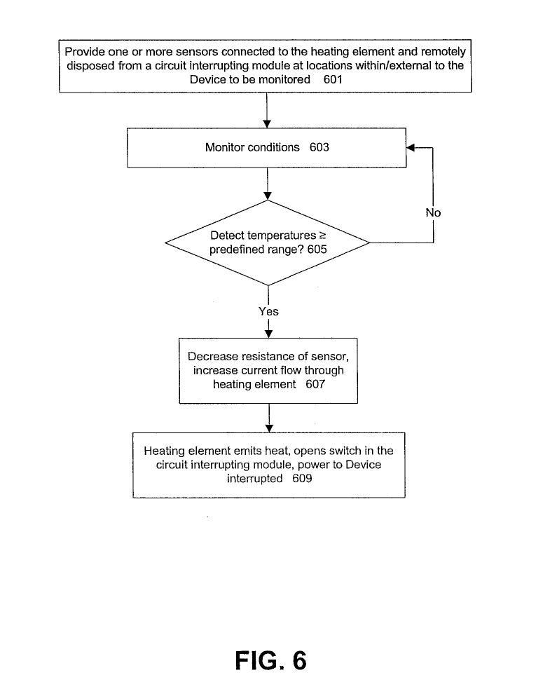

FIG. 6 is a flow diagram of an exemplary method for providing a sensor-activated circuit-interrupting system and monitoring one or more locations of a device according to one embodiment. In step 601, one or more sensors (e.g., thermal sensors) may be provided in communication with at least one heating element. The one or more sensors may be provided remotely disposed from a circuit-interrupting module at locations within/external to a device desired to be monitored. Monitoring may comprise monitoring for unsafe thermal conditions, e.g., temperatures which meet or exceed a predetermined threshold.

Each of the sensors and the bimetal actuator may be designed and configured at time of manufacture to be activated by any desired temperature level and/or resistance.

In step 603, each of the sensor(s) monitors the conditions at their respective locations. In step 605, each sensor ascertains whether a temperature meets and/or exceeds a predefined threshold or range. If no, the process returns to block 603 for continuous monitoring. If yes, the resistance of the sensor(s) is increased (e.g., due to the increased temperatures) thus increasing current flow through the heating element (step 607). Accordingly, the heating element emits heat, which activates the circuit-interrupting module by opening a switch/bimetal actuator, thus interrupting power to the device being monitored.

Advantageously, the bi-metal actuator according to the present principles does not have to be located or placed in direct proximity to the potential heat source of a device. It can be placed in any desired convenient location and due to its communication with one or more remote sensors (the sensor being connected in series or parallel with the heating element) and thus its resultant remote sensing capabilities, a circuit-interrupting module according to the present invention can monitor multiple locations at the same time. The remote sensors control the heating element that is attached to the bi-metal actuator.

Although illustrative embodiments of the present invention have been described herein with reference to the accompanying drawings, it is to be understood that the present invention is not limited to those precise embodiments, and that various other changes and modifications may be affected therein by one skilled in the art without departing from the scope or spirit of the present invention. All such changes and modifications are intended to be included within the scope of the invention as defined by the appended claims.

What is claimed is:

1. A circuit-interrupting system for interrupting an electrical current to a device comprising:
a relay assembly configured to be operable in a closed state when a sensed temperature is below a predetermined threshold, thereby maintaining electrical current to the device, and an open state when the sensed temperature is above the predetermined threshold, thereby interrupting the electrical current to the device;
a heater element proximal to said relay assembly and being configured to activate at least the open state of the relay assembly;
at least one sensor in electrical communication with said heater element, said at least one sensor being disposed remote from said relay assembly and being configured for sensing temperatures, wherein when the sensed temperature at said at least one sensor is above the predetermined threshold, the at least one sensor is configured to cause the heater element to activate the open state of the relay assembly.

2. The system of claim 1, wherein the relay assembly comprises a bimetal actuator.

3. The system of claim 1, wherein the open state of the relay assembly is activated by heat emitted from the heater element.

4. The system of claim 1, wherein the heating element and the at least one sensor comprise a sensing circuit.

5. The system of claim 4, wherein the sensing circuit comprises the heating element and a plurality of sensors operatively connected in a network.

6. The system of claim 4, wherein when the at least one sensor detects a temperature above a predetermined threshold, the electrical current is increased through the sensing circuit.

7. The system of claim 4, wherein the sensing circuit includes a holding sensor in electrical communication with and in proximity to said heater element, said holding sensor configured to be activated by the open state of the relay assembly.

8. The system of claim 7, wherein the holding sensor is configured to maintain the electrical current through the sensing circuit when said holding sensor is activated.

9. The system of claim 1, further comprising an alert module operatively connected to at least one of the relay assembly or said at least one sensor for providing at least one of an audio or visual alert during activation of the open state of the relay assembly.

10. A circuit-interrupting system for interrupting an electrical current to a device comprising:
a relay assembly configured to be operable in a closed state for maintaining electrical current to the device, and an open state for stopping the electrical current to the device; and
a sensing circuit comprising
a heating element proximal to said relay assembly and being configured to activate at least the open state of the relay assembly; and
at least one sensor in electrical communication with said heating element, said at least one sensor being disposed remote from said relay assembly.

11. The system of claim 10, wherein the at least one sensor is configured for sensing temperatures, wherein when a sensed temperature at said at least one sensor is above the predetermined threshold, the at least one sensor being configured to cause the heater element to activate the open state of the relay assembly.

12. The system of claim 10, wherein the relay assembly comprises a bimetal actuator.

13. The system of claim 10, wherein the open state of the relay assembly is activated by heat emitted from the heater element.

14. The system of claim 10, wherein the sensing circuit comprises the heating element and a plurality of sensors operatively connected in a network.

15. The system of claim 10, wherein when the at least one sensor detects a temperature above a predetermined threshold, the electrical current is increased through the sensing circuit.

16. The system of claim 10, wherein the sensing circuit includes a holding sensor in electrical communication with and in proximity to said heater element, said holding sensor configured to be activated by the open state of the relay assembly.

17. The system of claim 16, wherein the holding sensor is configured to maintain the electrical current through the sensing circuit when said holding sensor is activated.

18. The system of claim 10, further comprising an alert module operatively connected to at least one of the relay assembly or said at least one sensor for providing at least one of an audio or visual alert during activation of the open state of the relay assembly.

19. A circuit-interrupting system for interrupting an electrical current to a device comprising:
a relay assembly configured to be operable in a closed state for maintaining electrical current to the device, and an open state for interrupting the electrical current to the device;
a heater element proximal to said relay assembly and being configured to activate at least the open state of the relay assembly;
at least one sensor in electrical communication with said heater element, said at least one sensor being disposed remote from said relay assembly and being configured for sensing temperatures, wherein when the sensed temperature at said at least one sensor is above the predetermined threshold, the at least one sensor is configured to cause the heater element to activate the open state of the relay assembly; and
a holding sensor in electrical communication with and in proximity to said heater element, said holding sensor configured to be activated by the open state of the relay assembly.

20. The system of claim 19, further comprising an alert module operatively connected to at least one of the relay assembly or said at least one sensor for providing at least one of an audio or visual alert during activation of the open state of the relay assembly.
